(19) United States
(12) Patent Application Publication
(10) Pub. No.: US 2025/0021213 A1
(43) Pub. Date: Jan. 16, 2025

(54) METHOD FOR CONTROLLING PAGE DISPLAY, MOBILE TERMINAL, AND STORAGE MEDIUM

(71) Applicant: Beijing Zitiao Network Technology Co., Ltd., Beijing (CN)

(72) Inventors: Haiqiang JIANG, Beijing (CN); Haiyang GUO, Beijing (CN); Chen ZHAO, Beijing (CN); Dongdong ZUO, Beijing (CN); Shuji LIN, Beijing (CN); Mengyuan HAN, Beijing (CN); Yanting HUA, Beijing (CN)

(21) Appl. No.: 18/713,557

(22) PCT Filed: Jan. 3, 2023
(86) PCT No.: PCT/CN2023/070041

§ 371 Date: May 24, 2024

(30) Foreign Application Priority Data
Jan. 12, 2022 (CN) 202210032166.6

(51) Int. Cl. G06F 3/0483; G06F 3/0346; G06F 3/0484; H04N 23/63

(52) U.S. Cl. CPC G06F 3/0483; G06F 3/0346; G06F 3/0484; H04N 23/632

(57) ABSTRACT

A method and apparatus for controlling page display, a storage medium, and a mobile terminal are provided. The method for controlling page display includes: fixedly displaying a virtual viewing frame in a target page of a mobile terminal and showing a first page content of a preset virtual scene page in the virtual viewing frame, where the preset virtual scene page is associated with a preset theme, and associated information of the preset theme is shown outside the virtual viewing frame in the target page; and obtaining target motion data of the mobile terminal and transitioning from showing the first page content to showing a second page content based on the target motion data to realize sliding showing of the preset virtual scene page in the virtual viewing frame.

### CROSS-REFERENCE TO RELATED APPLICATION

The present application claims priority of the Chinese Patent Application No. 202210032166.6, filed on Jan. 12, 2022, the entire disclosure of which is incorporated herein by reference as part of the present application.

### TECHNICAL FIELD

The present disclosure relate to the technical field of computers, and for example, to a method and apparatus for controlling page display, a mobile terminal, and a storage medium.

### BACKGROUND

With the popularity of mobile terminals, mobile terminal devices such as mobile phones have become necessary tools in people's work and life.

A mobile terminal can display a plurality of pages, and a user may input gesture operations such as sliding by a screen of the mobile terminal to cause a currently displayed page content to change, thus browsing more contents in the page. However, the page display control solution described above is tedious, involves only a single human-machine interaction style, and needs to be improved.

### SUMMARY

Embodiments of the present disclosure provides a method and apparatus for controlling page display, a storage medium, and a mobile terminal to optimize the solution for controlling page display.

In a first aspect, the present disclosure provide a method for controlling page display, and the method includes:
fixedly displaying a virtual viewing frame in a target page of a mobile terminal and showing a first page content of a preset virtual scene page in the virtual viewing frame, where the preset virtual scene page is associated with a preset theme, and associated information of the preset theme is shown outside the virtual viewing frame in the target page; and
obtaining target motion data of the mobile terminal and transitioning from showing the first page content to showing a second page content of the preset virtual scene page in the virtual viewing frame based on the target motion data to realize sliding showing of the preset virtual scene page in the virtual viewing frame.

In a second aspect, the present disclosure provide an apparatus for controlling page display, and the apparatus includes:
a display module, configured to fixedly display a virtual viewing frame in a target page of a mobile terminal and show a first page content of a preset virtual scene page in the virtual viewing frame, wherein the preset virtual scene page is associated with a preset theme, and associated information of the preset theme is shown outside the virtual viewing frame in the target page; and
a content changing module, configured to obtain target motion data of the mobile terminal and transition from showing the first page content to showing a second page content of the preset virtual scene page in the virtual viewing frame based on the target motion data to realize sliding showing of the preset virtual scene page in the virtual viewing frame.

In a third aspect, the present disclosure provide a mobile terminal, and the mobile terminal includes a memory, a processor, and computer programs stored on the memory and runnable on the processor. The processor, upon executing the computer programs, implements the above method for controlling page display.

In a forth aspect, the present disclosure provide a computer-readable storage medium storing computer programs. The programs, upon being executed by a processor, implement the above method for controlling page display.

In a fifth aspect, the present disclosure provide a computer program product, which includes computer programs carried on a non-transitory computer-readable medium. The computer programs include program codes for executing the above method for controlling page display.

### BRIEF DESCRIPTION OF DRAWINGS

FIG. 1 is a flowchart of a method for controlling page display provided in an embodiment of the present disclosure;

FIG. 2 is a schematic diagram of a page display changing process provided in an embodiment of the present disclosure;

FIG. 3 is a flowchart of another method for controlling page display provided in an embodiment of the present disclosure;

FIG. 4 is a schematic diagram of another page display changing process provided in an embodiment of the present disclosure;

FIG. 5 is a flowchart of a further another method for controlling page display provided in an embodiment of the present disclosure;

FIG. 6 is a schematic diagram of a further another page display changing process provided in an embodiment of the present disclosure;

FIG. 7 is a structural block diagram of an apparatus for controlling page display provided in an embodiment of the present disclosure; and

FIG. 8 is a structural block diagram of a mobile terminal provided in an embodiment of the present disclosure.

### DETAILED DESCRIPTION

Embodiments of the present disclosure are described in detail below with reference to the drawings. Although some embodiments of the present disclosure are shown in the drawings, the present disclosure may be achieved in a plurality of forms. These embodiments are provided to understand the present disclosure. The drawings and the embodiments of the present disclosure are only for exemplary purposes.

A plurality of steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

Concepts such as “first” and “second” mentioned in the present disclosure are only used to distinguish different apparatuses, modules or units, and are not intended to limit orders or interdependence relationships of functions performed by these apparatuses, modules or units.

Modifications of “one” and “more” mentioned in the present disclosure are schematic rather than restrictive, and those skilled in the art should understand that unless otherwise stated in the context, it should be understood as “one or more”.

Names of messages or information exchanged between a plurality of apparatuses in embodiments of the present disclosure are only used for the purpose of description and not meant to limit the scope of these messages or information.

Both of optional features and examples are provided in a plurality of embodiments as will be described below. A plurality of features described in the embodiments may be combined to form a plurality of optional solutions. Each numbered embodiment shall not be merely considered as a technical solution.

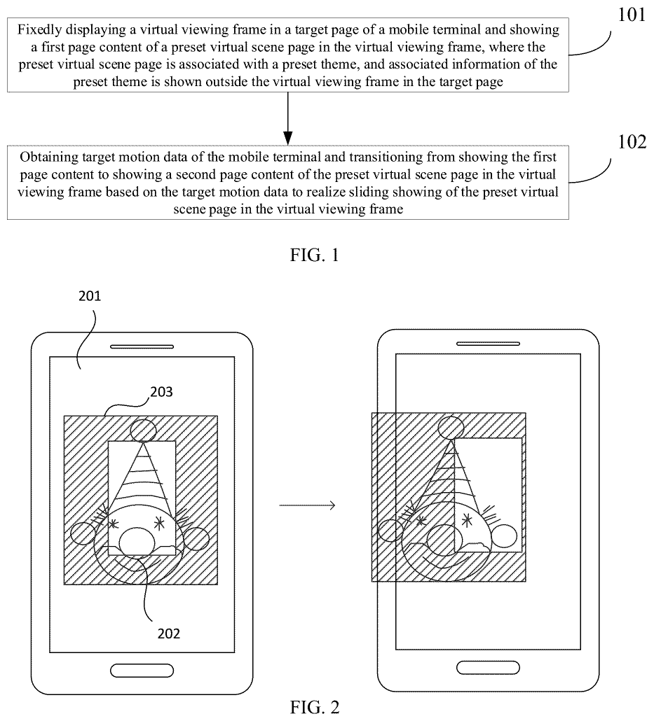

FIG. 1 is a flowchart of a method for controlling page display provided in an embodiment of the present disclosure. The method may be performed by an apparatus for controlling page display, where the apparatus may be implemented by software and/or hardware and may be generally integrated in a mobile terminal. The mobile terminal may be a mobile device such as a mobile phone, a smart watch, smart glasses, a tablet computer, and a personal digital assistant, which will not be particularly limited. As shown in FIG. 1, the method includes the following steps.

At step 101, a virtual viewing frame is fixedly displayed in a target page of a mobile terminal and a first page content of a preset virtual scene page is shown in the virtual viewing frame, where the preset virtual scene page is associated with a preset theme, and associated information of the preset theme is shown outside the virtual viewing frame in the target page.

In an embodiment of the present disclosure, the target page may be a page in a preset application (App) that is installed in the mobile terminal. There is no limitation on the type of the preset App, such as a social App, a live streaming App, a video App, or an information App.

Exemplarily, the virtual viewing frame is displayed at a preset display position in the target page. The preset display position is fixed in the target page. The position is not limited, and may be, for example, a central position, a middle lower position, or an upper right position of the target page. A size of the virtual viewing frame is smaller than that of the target page. A representation form, a shape, a specific size and the like of the virtual viewing frame are not limited. The virtual viewing frame may be designed according to an actual demand, e.g., designed into a frame having a visual effect of an open door, and a related special effect may also be shown to increase the aesthetic degree of the virtual viewing frame.

In an embodiment of the present disclosure, the preset virtual scene page may be set in advance. The preset virtual scene page may be a preset virtual scene for the virtual viewing frame to find a view. The preset virtual scene page may be a page in which the preset virtual scene page is presented. The preset virtual scene page is associated with the preset theme. The preset theme may be a theme set by a platform of the preset App. There is no limitation on a theme type, a theme content and the like. For example, a theme related to a festival (such as Spring Festival, Valentine's Day, or Teeth-Care Day), a theme related to an event (such as first snow, school opening, or new App function), or other themes set by the platform may be possible. The theme may be an activity launched by the platform of the preset App, such as a Spring Festival activity. There is no particular limitation on a content in the preset virtual scene page, a showing form thereof, and the like. The content may be an image, a text, or a video, and the corresponding showing form may be displaying the image or the text, playing the video, or the like. The size of the virtual viewing frame is smaller than that of the target page. The information associated with the preset theme, such as detailed information of the preset theme or a background image of the preset theme, may be shown in a page region other than the virtual viewing frame in the target page.

In an embodiment of the present disclosure, the size of the preset virtual scene page is greater than the size of the virtual viewing frame. At any time, the virtual viewing frame can only show part of the page content in the preset virtual scene page, and the page content not shown may be in a blocked state. FIG. 2 is a schematic diagram of a page display changing process provided in an embodiment of the present disclosure. Exemplarily, the virtual viewing frame 202 is displayed in the target page 201. The page content in the preset virtual scene page 203 is shown in the virtual viewing frame 202, and the part in the virtual viewing frame 202 in the preset virtual scene page 203 is the page content that is currently being shown, while the shaded part in the preset virtual scene page 203 is the page content that is not shown and invisible for a user. As shown in FIG. 2, it is assumed that the preset virtual scene page 203 is associated with the Spring Festival theme, and the preset virtual scene page 203 includes a complete clown image. Part of the hat, the eyes, the nose and the like of the clown are currently shown in the virtual viewing frame 202, while the two ears and the mouth cannot be shown temporarily. The virtual viewing frame 202 may show the associated information (not shown) of the Spring Festival theme, such as a background image of “Happy Spring Festival”. In FIG. 2, for convenience of description, the size of the preset virtual scene page is smaller than a screen size of the mobile terminal. In practical use, the size of the preset virtual scene page may also be greater than or equal to the screen size of the mobile terminal.

Exemplarily, the first page content may be part of the page content in the preset virtual scene page that is currently shown in the virtual viewing frame, which may be the page content initially shown in the virtual viewing frame upon entering the target page or may be the page content shown at any time in the display process of the target page. For the case of just entering the target page, the initially shown page content may be set in advance or may be determined according to a current state of the mobile terminal and/or the preset App. For example, an inclination angle of the screen of the mobile terminal relative to the horizontal plane is detected and the initially shown page content is determined based on the inclination angle.

At step 102, target motion data of the mobile terminal is obtained and showing the first page content is transitioned to showing a second page content of the preset virtual scene page in the virtual viewing frame based on the target motion data to realize dynamic sliding showing of the preset virtual scene page in the virtual viewing frame.

Exemplarily, when using the mobile terminal, the user usually needs to contact the mobile terminal using a body part, thereby fixing the mobile terminal. For example, a mobile phone is held by a hand, a smart watch is worn on a wrist, or smart glasses are worn on a head. The user may control the motion of the mobile terminal by means of the movement of the body part.

In an embodiment of the present disclosure, the motion data may include a speed, an acceleration, an angular velocity, angular acceleration, and the like, and may also include a motion direction, a motion distance, a rotation angle, and the like. After entering the target page, the motion data of the mobile terminal may be obtained by a motion sensor in the mobile terminal. The motion sensor may include, e.g., an acceleration sensor, a gyroscope, and an electronic compass. The target motion data may be the currently obtained motion data.

In an embodiment of the present disclosure, the user may control the mobile terminal to move to cause sliding showing of the preset virtual scene page in the virtual viewing frame. That is, the preset virtual scene page is caused to slide relative to the virtual viewing frame, which in turn causes the page content shown in the virtual viewing frame to change, transitioning from showing the first page content to showing the second page content. The transitioning may be a gradual and continuous change from showing the first page content to showing the second page content, with the first page content gradually disappearing from the virtual viewing frame and the second page content gradually appearing in the virtual viewing frame. The content between the first page content and the second page content can also be shown such that the user can browse the continuously changing page content. Exemplarily, a sliding direction and a sliding distance of the preset virtual scene page may be determined based on the target motion data, and then the second page content to be shown is determined. A target change amount of a current attitude of the mobile terminal compared to that when entering the target page may also be determined based on the target motion data, and a preset corresponding relationship is queried based on the target change amount to obtain the corresponding second page content. The preset corresponding relationship may include a corresponding relationship between different motion data and picture contents of a preset virtual scene picture.

As shown in FIG. 2, after the user controls the mobile terminal to move, the mobile terminal may enable transitional showing of the page content based on the obtained target motion data, transitioning from the first page content to the second page content. Taking the nose and the ear of the clown for example, the nose gradually slides leftwards from the virtual viewing frame and slowly out of the virtual viewing frame, while the ear gradually appears in and slides leftwards from the virtual viewing frame.

Exemplarily, the motion data may be obtained at a preset frequency which may be set according to an actual requirement. After the motion data is obtained each time, the current second page content is determined based on the currently obtained motion data and shown transitionally. When the preset frequency is high, a difference between the corresponding first page content and second page content during each transitional showing is small. For the user, the visual effect of real-time dynamic sliding showing of the preset virtual scene page can be achieved, and the feedback efficiency for the motion of the mobile terminal and the fluency of page content changing can be improved.

According to the method for controlling page display provided in the embodiment of the present disclosure, the virtual viewing frame is fixedly displayed in the target page of the mobile terminal and the first page content of the preset virtual scene page is shown in the virtual viewing frame, where the preset virtual scene page is associated with the preset theme, and the associated information of the preset theme is shown outside the virtual viewing frame in the target page. The target motion data of the mobile terminal is obtained and showing the first page content is transitioned to showing the second page content in the virtual viewing frame based on the target motion data to realize sliding showing of the preset virtual scene page in the virtual viewing frame. By adopting the above technical solution, the page content of the preset virtual scene page is displayed within the virtual viewing frame in the target page. The shown page content changes with the motion of the mobile terminal, simulating the visual effect of the content to be shot changing in the virtual viewing frame by following the motion of the mobile terminal. The interestingness of page display and human-machine interaction may be improved and the page browsing experience may be enhanced.

In some embodiments, transitioning from showing the first page content to showing the second page content of the preset virtual scene page in the virtual viewing frame based on the target motion data includes: querying a preset mapping relationship based on the target motion data to obtain a target page moving vector corresponding to the target motion data, where the preset mapping relationship includes a corresponding relationship between different motion data and page moving vectors; determining the second page content of the preset virtual scene page based on the first page content and the target page moving vector; and transitioning from showing the first page content to showing the second page content in the virtual viewing frame. Such a setting has the following advantage: the second page content can be determined rapidly and accurately so that the showing efficiency of the page content can be improved.

Exemplarily, a page moving vector may be used to indicate a sliding direction and a sliding distance of the preset virtual scene page. The corresponding relationship between different motion data and page moving vectors may be established in advance to form the preset mapping relationship. After the current target motion data is obtained, the target page moving vector corresponding to the target motion data is queried in the preset mapping relationship and then the second page content is determined based on the first page content and the target page moving vector. A first center point of a first page region where the first page content is located may be used as a starting point of the target page moving vector and an ending point of the target page moving vector as a second center point of a second page region where the second page content to be determined is located, and then the second page content is determined according to the second center point and the size of the virtual viewing frame.

Exemplarily, the motion data includes a spatial rotation angle of a plane in which the screen of the mobile terminal is located. Such a setting has the following advantages: the user may enable the sliding showing of the preset virtual scene page by means of actions such as rotating or turning the mobile terminal without controlling the mobile terminal to move within a large range; the operation difficulty is reduced and the showing efficiency of the page content is improved. When a width of the preset virtual scene page is identical or approximate to that of the virtual viewing frame or when a height of the preset virtual scene page is identical or approximate to that of the virtual viewing frame, the motion data may include a rotation angle of the plane in which the screen of the mobile terminal is located relative to a preset rotation axis. The data size of the motion data needing to be obtained is reduced and the page content to be shown is determined more rapidly and accurately. The content showing efficiency is improved. For example, when the height of the preset virtual scene page is identical or approximate to that of the virtual viewing frame, the preset rotation axis may be a symmetric axis extending through an upper edge and a lower edge of the screen.

In some embodiments, the method further includes: entering a capture preview page in response to a triggering operation on the preset virtual scene page. Such a setting has the following advantages: the interest of the user in viewing more scenes and capturing more scenes by himself/herself can be enhanced by means of the sliding showing of the preset virtual scene page in the virtual viewing frame. After entering the capture preview page, the user may capture scenes according to his/her own preference. For example, a real-time preview image and a capture control are displayed in the capture preview page, and the capture control is triggered to enable image capture. The triggering operation for the preset virtual scene page may be, for example, a gesture operation acting on the preset virtual scene page (acting on the page content shown in the virtual viewing frame), such as tapping, and may also be a gesture operation acting on a set control associated with the preset virtual scene page, such as tapping on the button showing “enter the camera . . . ” at the bottom of the virtual viewing frame.

In some embodiments, after the entering the capture preview page, the method further includes: showing an associated element of the preset virtual scene page in the capture preview page. Such a setting has the following advantage: association of a virtual scene in the preset virtual scene page and a real scene may be established, enhancing the interestingness of capture.

Exemplarily, there is no limitation on a form and a content of the associated element. The associated element may be a content existing in the preset virtual scene page and may also be a content related to the page content in the preset virtual scene page. For example, a special effect, a cartoon image, a prop, or an identifier existing in the preset virtual scene page may be included. For another example, an element related to the preset theme associated with the preset virtual scene page may also be included. For example, the related elements of the Spring Festival theme may include Spring Festival scrolls, firecrackers, Chinese Zodiac, and the like, and the related elements of the Valentine's Day theme may include chocolate, rose, and the like.

In some embodiments, a first preset number of sub-theme entries of the preset theme are associated in the preset virtual scene page. While showing the second page content in the virtual viewing frame, the method further includes: showing a sub-theme entry associated with the second page content in the virtual viewing frame. Entering the capture preview page in response to the triggering operation for the preset virtual scene page and showing the associated element of the preset virtual scene page in the capture preview page includes: entering the capture preview page in response to a triggering operation for a target sub-theme entry and showing an associated element of the target sub-theme entry in the capture preview page, where the target sub-theme entry is the sub-theme entry associated with the second page content. Such a setting has the following advantages: a certain number of sub-theme entries are associated in the preset virtual scene page, and in the sliding showing process of the preset virtual scene page, the user may select and trigger a target sub-theme entry of interest from the sub-theme entries appearing in the virtual viewing frame, and then the associated element of the target sub-theme entry is shown in the capture preview page. The personalized capture demand of the user can be met. The copywriting of a sub-theme entry may indicate a type or content of the corresponding associated element, facilitating the selective triggering of the user.

In some embodiments, a second preset number of sub-theme objects of the preset theme are associated in the preset virtual scene page, and the virtual viewing frame includes a preset positioning identifier displayed fixedly. While showing the second page content in the virtual viewing frame, the method further includes: showing a sub-theme object associated with the second page content in the virtual viewing frame. Entering the capture preview page in response to the triggering operation for the preset virtual scene page and showing the associated element of the preset virtual scene page in the capture preview page includes: entering the capture preview page in the case of detecting a relative relationship of a first display region corresponding to the preset positioning identifier and a second display region corresponding to the target sub-theme object meeting a preset condition, and showing an associated element of the target sub-theme object in the capture preview page, where the target sub-theme entry is the sub-theme object associated with the second page content. Such a setting has the following advantages: a certain number of sub-theme objects are associated in the preset virtual scene page, and with the motion of the mobile terminal, both of the sub-theme object appearing within the virtual viewing frame and the display region corresponding to the sub-theme object appearing currently will change while the display region of the preset positioning identifier is fixed. Therefore, the user may cause the relative relationship of the sub-theme object and the preset positioning identifier to change by controlling the mobile terminal to move. When the relative relationship meets a certain condition, it can be determined that the sub-theme object meeting the condition is the target sub-theme object of interest selected by the user, and then the associated element of the target sub-theme object is shown in the capture preview page. The interestingness of the interaction process is enhanced whilst the personalized capture demand of the user is met. Optionally, the copywriting of the sub-theme object may indicate a type or content of the corresponding associated element, facilitating the purposeful control of the motion of the mobile terminal by the user.

Exemplarily, the relative relationship may, for example, include a relative relationship based on a position or a relative relationship based on an overlapping region. The relative relationship based on a position may, for example, include a distance of a first center point of the first display region from a second center point of a second display region, whether the first display region and the second display region intersect, and the like. The relative relationship based on an overlapping region may, for example, include an area of the overlapping region of the first display region and the second display region, a shape of the overlapping region, and the like. Exemplarily, the preset condition, e.g., the distance of the center point of the first display region from the center point of the second display region reaching a preset distance threshold, may be set according to an actual requirement.

In some embodiments, the relative relationship of the first display region corresponding to the preset positioning identifier and the second display region corresponding to the target sub-theme object meeting the preset condition includes: an area of an overlapping region of the first display region corresponding to the preset positioning identifier and the second display region corresponding to the target sub-theme object being greater than or equal to a preset area threshold. Such a setting has the following advantages: the user is enabled to observe the changes in the relative relationship between the sub-theme object to be selected and the preset positioning identifier more intuitively and then may control the motion of the mobile terminal more rapidly and accurately; and the interaction efficiency is improved. The preset area threshold may be set according to an actual requirement.

The relative relationship of the first display region corresponding to the preset positioning identifier and the second display region corresponding to the target sub-theme object meeting the preset condition includes: an area of an overlapping region of the first display region corresponding to the preset positioning identifier and the second display region corresponding to the target sub-theme object remaining greater than or equal to a preset area threshold within a preset duration. Such a setting has the following advantages: wrong selection of the sub-theme object can be effectively avoided. In the rapid motion process of the mobile terminal, it may be possible for a sub-theme object to rapidly overlap the preset positioning identifier so as to meet the preset condition, although the user may not intentionally select the sub-theme object. Therefore, when the user selects the target sub-theme object, the mobile terminal may stop moving or move within a small range, thereby guaranteeing that the area of the overlapping region of the first display region and the second display region is always greater than or equal to the preset area threshold within the preset duration and avoiding the case of wrong selection.

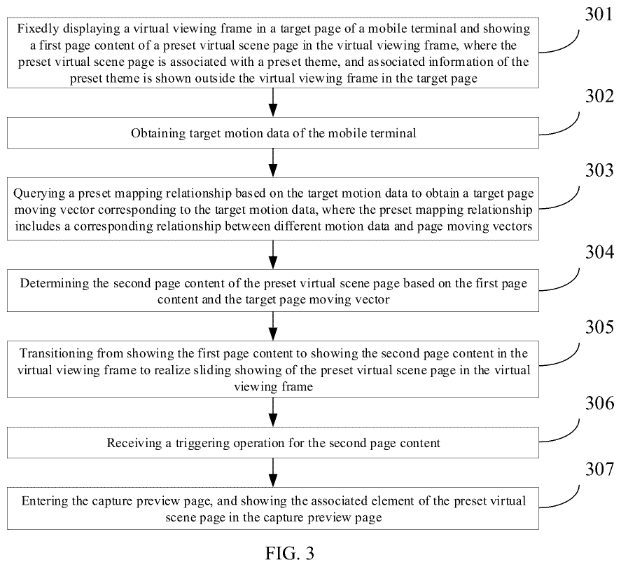

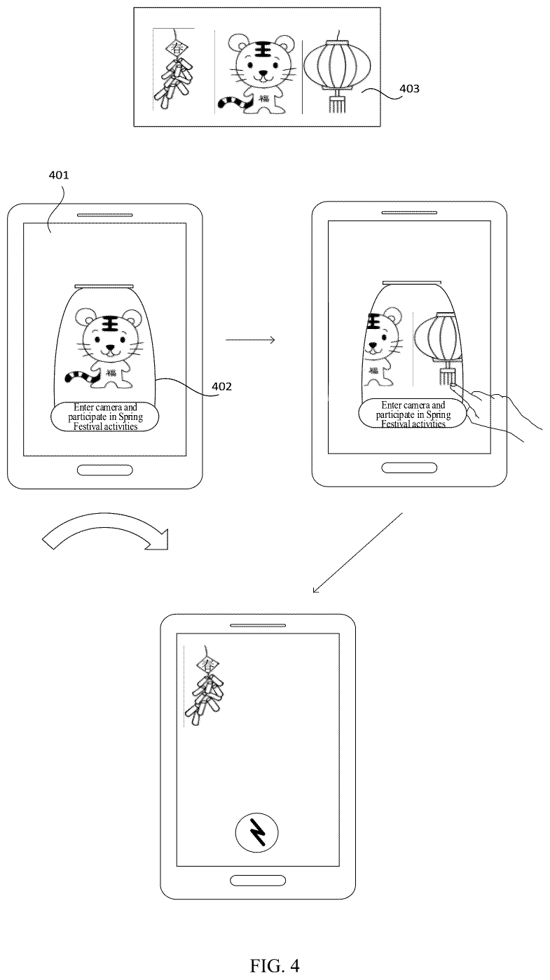

FIG. 3 is a flowchart of another method for controlling page display provided in an embodiment of the present disclosure, which is illustrated on the basis of the scheme in the above embodiments. The method includes the following steps.

At step 301, a virtual viewing frame is fixedly displayed in a target page of a mobile terminal and a first page content of a preset virtual scene page is shown in the virtual viewing frame, where the preset virtual scene page is associated with a preset theme, and associated information of the preset theme is shown outside the virtual viewing frame in the target page.

Exemplarily, the preset virtual scene page corresponds to the preset theme, and the content in the preset virtual scene page is the content related to the preset theme.

FIG. 4 is a schematic diagram of another page display changing process provided in an embodiment of the present disclosure. The preset virtual scene page corresponds to the Spring Festival theme. A door-shaped virtual viewing frame 402 is fixedly displayed in the target page 401. For example, a firework background image (not shown) may be displayed outside the virtual viewing frame 402. The preset virtual scene page 403 includes contents related to the Spring Festival theme, such as firecrackers, a little tiger image, and a lantern. The first page content of the preset virtual scene page 403 is shown in the virtual viewing frame 402. For example, the first page content includes the little tiger image.

At step 302, target motion data of the mobile terminal is obtained.

Exemplarily, the motion data includes a spatial rotation angle of a plane in which the screen of the mobile terminal is located. Related data such as an angular velocity may be obtained by using a gyroscope built in the mobile terminal, and a rotation angle is obtained in a computing mode such as integration. As shown in FIG. 4, the user controls the mobile terminal to rotate rightwards so that a rotation angle can be obtained.

At step 303, a preset mapping relationship is queried based on the target motion data to obtain a target page moving vector corresponding to the target motion data, where the preset mapping relationship includes a corresponding relationship between different motion data and page moving vectors.

Exemplarily, the corresponding relationship between different rotation angles and page moving vectors may be established in advance to obtain the preset mapping relationship. When the user controls the mobile terminal to move, the preset mapping relationship will be queried by using the target rotation angle detected by the gyroscope to obtain the corresponding target page moving vector.

At step 304, the second page content of the preset virtual scene page is determined based on the first page content and the target page moving vector.

As shown in FIG. 4, the second page content to be displayed is determined as the page content including part of the little tiger image and part of the lantern image based on the first page content and the target page moving vector.

At step 305, showing the first page content is transitioned to showing the second page content in the virtual viewing frame to realize sliding showing of the preset virtual scene page in the virtual viewing frame.

Exemplarily, the mobile terminal may be transitioned from showing the first page content to showing the second page content in the virtual viewing frame. As shown in FIG. 4, the little tiger image gradually slides leftwards from the virtual viewing frame, while the lantern gradually appears in and slides leftwards from the virtual viewing frame.

At step 306, a triggering operation for the second page content is received.

Exemplarily, when the user observes that the page content in the virtual viewing frame changes by turning the mobile terminal, the user may have the visual experience of seeing the scene in the door from outside the door, like capturing a Spring Festival theme scene using a camera, thus prompting the user to enter the camera function to participate in the interaction of the Spring Festival theme. At this time, the user may input the triggering operation for the second page content by tapping and the like, thereby triggering the enabling of the camera function.

At step 307, the capture preview page is entered, and the associated element of the preset virtual scene page is shown in the capture preview page.

Exemplarily, as shown in FIG. 4, after the camera function is enabled, the capture preview page is entered, and the firecracker element in the preset virtual scene page is shown in the capture preview page to heighten the festival atmosphere. The interest of the user in capture an image and participating in the interaction of the Spring Festival theme may be enhanced and the user may be helped to capture a high-quality image.

According to the method for controlling page display provided in the embodiment of the present disclosure, the virtual viewing frame is fixedly displayed in the target page of the mobile terminal and the first page content of the preset virtual scene page associated with the preset theme is shown in the virtual viewing frame. The rotation angle of the mobile terminal is detected using a sensor such as a gyroscope, and the second page content to be shown is determined based on the rotation angle, and showing the first page content is transitioned to showing the second page content in the virtual viewing frame to realize sliding showing of the preset virtual scene page in the virtual viewing frame. After the user inputs the triggering operation for the second page content, the camera function is enabled to enter a capture preview interface and display the associated element. By adopting the above technical solution, the user may control the mobile terminal to rotate to cause sliding showing of the content of the preset virtual scene page in the virtual viewing frame. The interestingness of page display and human-machine interaction may be improved; the page browsing experience may be enhanced; and the interaction forms for the user entering the camera function and participating in the Spring Festival theme are enriched.

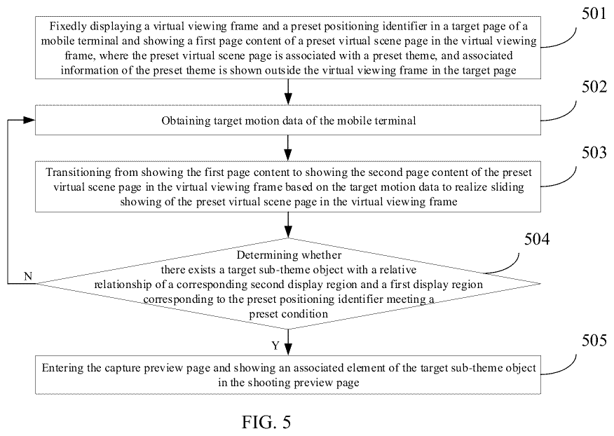

FIG. 5 is a flowchart of a further another method for controlling page display provided in an embodiment of the present disclosure, which is illustrated on the basis of the scheme in the above embodiments. As shown in FIG. 5, the method includes the following steps.

At step 501, a virtual viewing frame and a preset positioning identifier are fixedly displayed in a target page of a mobile terminal and a first page content of a preset virtual scene page is shown in the virtual viewing frame, where the preset virtual scene page is associated with a preset theme, and associated information of the preset theme is shown outside the virtual viewing frame in the target page.

Exemplarily, a preset number of sub-theme objects are associated in the preset virtual scene page, and the virtual viewing frame includes the preset positioning identifier displayed fixedly.

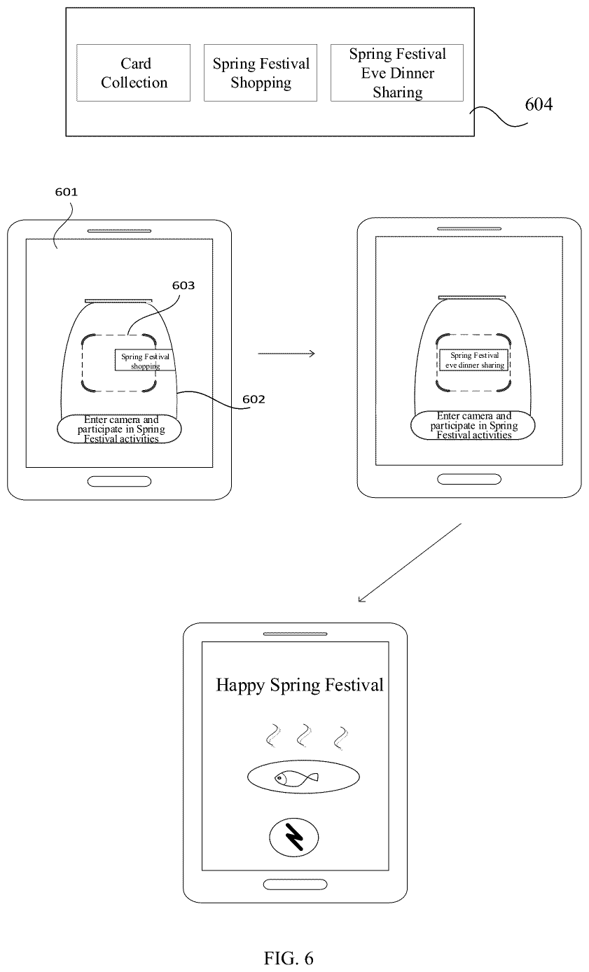

FIG. 6 is a schematic diagram of another page display changing process provided in an embodiment of the present disclosure. The preset virtual scene page corresponds to the Spring Festival theme. The virtual viewing frame 602 is fixedly displayed in the target page 601. The preset positioning identifier 603 displayed fixedly is set within the virtual viewing frame 602. The preset virtual scene page 604 includes 3 sub-theme objects that respectively correspond to 3 sub-themes: card collection, Spring Festival shopping, and Spring Festival eve dinner sharing, and may also include other page contents (not shown). The first page content of the preset virtual scene page 604 is shown in the virtual viewing frame 602. For example, the first page content includes part of the content of Spring Festival shopping.

At step 502, target motion data of the mobile terminal is obtained.

At step 503, showing the first page content is transitioned to showing the second page content of the preset virtual scene page in the virtual viewing frame based on the target motion data to realize sliding showing of the preset virtual scene page in the virtual viewing frame.

Exemplarily, the mobile terminal may be transitioned from showing the first page content to showing the second page content in the virtual viewing frame. As shown in FIG. 6, Spring Festival shopping gradually slides leftwards and disappears from the virtual viewing frame, while Spring Festival eve dinner sharing gradually appears in and slides leftwards from the virtual viewing frame.

At step 504, whether there exists a target sub-theme object with a relative relationship of a corresponding second display region and a first display region corresponding to the preset positioning identifier meeting a preset condition is determined. If a target sub-theme object with a relative relationship of a corresponding second display region and a first display region corresponding to the preset positioning identifier meeting a preset condition exists, step 505 is performed. If a target sub-theme object with a relative relationship of a corresponding second display region and a first display region corresponding to the preset positioning identifier meeting a preset condition does not exist, step 502 is returned to be performed.

Exemplarily, if an area of an overlapping region of the first display region corresponding to the preset positioning identifier and the second display region corresponding to a sub-theme object remains greater than or equal to a preset area threshold within a preset duration, it is determined that the target sub-theme object exists.

As shown in FIG. 6, it is assumed that the preset duration is 3 seconds, and when the sub-theme object of Spring Festival eve dinner sharing falls within the display region in which the preset positioning identifier is located and holds for 3 seconds after the user controls the mobile terminal to move, it may be considered that the user wants to select to enter the camera to capture an image related to the Spring Festival eve dinner.

At step 505, the capture preview page is entered and an associated element of the target sub-theme object is shown in the capture preview page.

Exemplarily, as shown in FIG. 6, after the camera function is enabled, the capture preview page is entered, and the associated elements of Spring Festival eve dinner sharing are shown in the capture preview page, such as a special effect of virtual steaming and wordart sticker of Happy Spring Festival. The user may combine a capture object (e.g., braised fish as shown) with the associated elements to rapidly capture a high-quality image. A changing operation of the user acting on the associated element may be received, such as changing a display position of the associated element, to realize personalized capture.

According to the method for controlling page display provided in the embodiment of the present disclosure, the virtual viewing frame and the preset positioning identifier are fixedly displayed in the target page of the mobile terminal and the first page content of the preset virtual scene page corresponding to the preset theme and the associated sub-theme object are shown in the virtual viewing frame. The second page content to be shown is determined based on the motion data of the mobile terminal, and showing the first page content is transitioned to showing the second page content in the virtual viewing frame to realize sliding showing of the preset virtual scene page in the virtual viewing frame. When the user controls the mobile terminal to move to cause that the relative relationship of the target sub-theme object and the display region of the preset positioning identifier meets the preset condition, the camera function is enabled to enter the capture preview interface and display the associated element of the target sub-theme object. By adopting the above technical solution, the user may control the mobile terminal to rotate to cause sliding showing of the content of the preset virtual scene page in the virtual viewing frame and to change the relative relationship between the sub-theme object and the preset positioning identifier, thus triggering the capture function and participating in the interaction of the preset theme. The interestingness of page display and human-machine interaction may be improved; meanwhile, the image capture efficiency is improved so that a shot image related to the preset theme can be obtained rapidly; thus, the human-machine interaction efficiency can be improved.

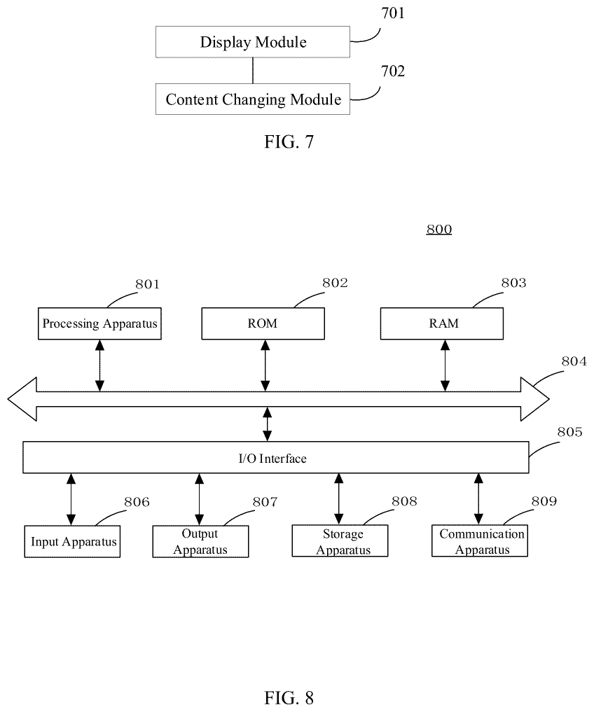

FIG. 7 is a structural block diagram of an apparatus for controlling page display provided in an embodiment of the present disclosure. The apparatus may be implemented by software and/or hardware, may be generally integrated in a mobile terminal, and may carry out page display control by performing the method for controlling page display. As shown in FIG. 7, the apparatus includes:
a display module 701 configured to fixedly display a virtual viewing frame in a target page of a mobile terminal and show a first page content of a preset virtual scene page in the virtual viewing frame, where the preset virtual scene page is associated with a preset theme, and associated information of the preset theme is shown outside the virtual viewing frame in the target page; and a content changing module 702 configured to obtain target motion data of the mobile terminal and transition from showing the first page content to showing a second page content of the preset virtual scene page in the virtual viewing frame based on the target motion data to realize sliding showing of the preset virtual scene page in the virtual viewing frame.

According to the apparatus for controlling page display provided in the embodiment of the present disclosure, the virtual viewing frame is fixedly displayed in the target page of the mobile terminal and the first page content of the preset virtual scene page is shown in the virtual viewing frame. The target motion data of the mobile terminal is obtained and showing the first page content is transitioned to showing the second page content in the virtual viewing frame based on the target motion data to realize sliding showing of the preset virtual scene page in the virtual viewing frame. By adopting the above technical solution, the page content of the preset virtual scene page is displayed within the virtual viewing frame in the target page. The shown page content changes with the motion of the mobile terminal, simulating the visual effect of the content to be shot changing in the virtual viewing frame by following the motion of the mobile terminal. The interestingness of page display and human-machine interaction may be improved and the page browsing experience may be enhanced.

In an embodiment, the content changing module 702 includes:
a motion data obtaining unit configured to obtain the target motion data of the mobile terminal; a vector querying unit configured to query a preset mapping relationship based on the target motion data to obtain a target page moving vector corresponding to the target motion data, where the preset mapping relationship includes a corresponding relationship between different motion data and page moving vectors; a content determining unit configured to determine the second page content of the preset virtual scene page based on the first page content and the target page moving vector; and a content changing unit configured to transition from showing the first page content to showing the second page content in the virtual viewing frame.

In an embodiment, the motion data includes a spatial rotation angle of a plane in which a screen of the mobile terminal is located.

In an embodiment, the apparatus further includes:
a triggering response module configured to enter a capture preview page in response to a triggering operation for the preset virtual scene page.

In an embodiment, the apparatus further includes:
an element showing module configured to, after entering the capture preview page, show an associated element of the preset virtual scene page in the capture preview page.

In an embodiment, a first preset number of sub-theme entries of the preset theme are associated in the preset virtual scene page. The apparatus further includes:
a sub-theme entry showing module configured to, while showing the second page content in the virtual viewing frame, show a sub-theme entry associated with the second page content in the virtual viewing frame. The entering the capture preview page in response to the triggering operation for the preset virtual scene page includes: entering the capture preview page in response to a triggering operation for a target sub-theme entry; and the showing the associated element of the preset virtual scene page in the capture preview page includes: showing the associated element of the target sub-theme entry in the capture preview page, where the target sub-theme entry is the sub-theme entry associated with the second page content.

In an embodiment, a second preset number of sub-theme objects of the preset theme are associated in the preset virtual scene page, and the virtual viewing frame includes a preset positioning identifier displayed fixedly. The apparatus further includes:
a sub-theme object showing module configured to, while showing the second page content in the virtual viewing frame, show a sub-theme object associated with the second page content in the virtual viewing frame. The entering the capture preview page in response to the triggering operation for the preset virtual scene page includes: entering the capture preview page in the case of detecting a relative relationship of a first display region corresponding to the preset positioning identifier and a second display region corresponding to the target sub-theme object meeting a preset condition; and the showing the associated element of the preset virtual scene page in the capture preview page includes: showing the associated element of the target sub-theme object in the capture preview page, where the target sub-theme entry is the sub-theme object associated with the second page content.

In an embodiment, the relative relationship of the first display region corresponding to the preset positioning identifier and the second display region corresponding to the target sub-theme object meeting the preset condition includes:
an area of an overlapping region of the first display region corresponding to the preset positioning identifier and the second display region corresponding to the target sub-theme object remaining greater than or equal to a preset area threshold within a preset duration.

FIG. 8 is specifically referred below, and it shows the structure schematic diagram suitable for achieving the mobile terminal 800 in the embodiment of the present disclosure. The mobile terminal 800 in the embodiment of the present disclosure may include but not be limited to a mobile terminal such as a mobile phone, a notebook computer, a digital broadcasting receiver, a personal digital assistant (PDA), a portable android device (PAD), a portable multimedia player (PMP), a vehicle terminal (such as a vehicle navigation terminal), and a fixed terminal such as a digital television (TV) and a desktop computer. The mobile terminal 800 shown in FIG. 8 is only an example and should not impose any limitations on the functions and use scopes of the embodiments of the present disclosure.

As shown in FIG. 8, the mobile terminal 800 may include a processing apparatus (such as a central processing unit, and a graphics processor) 801, it may execute a plurality of appropriate actions and processes according to a program stored in a read-only memory (ROM) 802 or a program loaded from a storage apparatus 808 to a random access memory (RAM) 803. In RAM 803, a plurality of programs and data required for operations of the mobile terminal 800 are also stored. The processing apparatus 801, ROM 802, and RAM 803 are connected to each other by a bus 804. An input/output (I/O) interface 805 is also connected to the bus 804.

Typically, the following apparatuses may be connected to the I/O interface 805: an input apparatus 806 such as a touch screen, a touchpad, a keyboard, a mouse, a camera, a microphone, an accelerometer, and a gyroscope; an output apparatus 807 such as a liquid crystal display (LCD), a loudspeaker, and a vibrator; a storage apparatus 808 such as a magnetic tape, and a hard disk drive; and a communication apparatus 809. The communication apparatus 809 may allow the mobile terminal 800 to wireless-communicate or wire-communicate with other devices so as to exchange data. Although FIG. 8 shows the mobile terminal 800 with a plurality of apparatuses, it is not required to implement or possess all the apparatuses shown. Alternatively, it may implement or possess the more or less apparatuses.

According to the embodiment of the present disclosure, the process described above with reference to the flowchart may be achieved as a computer software program. For example, an embodiment of the present disclosure includes a computer program product, it includes a computer program loaded on a non-transitory computer-readable medium, and the computer program includes program codes for executing the method shown in the flowchart. In such an embodiment, the computer program may be downloaded and installed from the network by the communication apparatus 809, or installed from the storage apparatus 808, or installed from ROM 802. When the computer program is executed by the processing apparatus 801, the above functions defined in the method in the embodiments of the present disclosure are executed.

The above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More examples of the computer-readable storage medium may include but not be limited to: an electric connector with one or more wires, a portable computer magnetic disk, a hard disk drive, a RAM, a ROM, an erasable programmable read-only memory (EPROM or flash memory), an optical fiber, a compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt a plurality of forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

The above-mentioned computer-readable medium may be included in the mobile terminal described above, or may exist alone without being assembled into the mobile terminal.

The above-mentioned computer-readable medium carries one or more programs which, when executed by the mobile terminal, cause the mobile terminal to: fixedly display the virtual viewing frame in the target page of the mobile terminal and show the first page content of the preset virtual scene page in the virtual viewing frame, where the preset virtual scene page is associated with the preset theme, and the associated information of the preset theme is shown outside the virtual viewing frame in the target page; obtain the target motion data of the mobile terminal and transition from showing the first page content to showing the second page content of the preset virtual scene page in the virtual viewing frame based on the target motion data to realize sliding showing of the preset virtual scene page in the virtual viewing frame.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including local area network (LAN) or wide area network (WAN), or may be connected to an external computer (such as connected by using an internet service provider through the Internet).

The flowcharts and the block diagrams in the drawings show possibly achieved system architectures, functions, and operations of systems, methods, and computer program products according to various embodiments of the present disclosure. At this point, each box in the flowchart or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flowchart, as well as combinations of the boxes in the block diagram and/or the flowchart, may be achieved by using a dedicated hardware-based system that performs the specified function or operation, or may be achieved by using combinations of dedicated hardware and computer instructions.

The involved modules described in the embodiments of the present disclosure may be achieved by a mode of software, or may be achieved by a mode of hardware. The name of the module does not constitute a limitation for the module itself in a case. For example, the display module may also be described as “a module for fixedly displaying a virtual viewing frame in a target page of a mobile terminal and showing a first page content of a preset virtual scene page in the virtual viewing frame, where the preset virtual scene page is associated with a preset theme, and associated information of the preset theme is shown outside the virtual viewing frame in the target page”.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard part (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

One or more embodiments of the present disclosure provide a method for controlling page display, and the method includes:
fixedly displaying a virtual viewing frame in a target page of a mobile terminal and showing a first page content of a preset virtual scene page in the virtual viewing frame, where the preset virtual scene page is associated with a preset theme, and associated information of the preset theme is shown outside the virtual viewing frame in the target page; and
obtaining target motion data of the mobile terminal and transitioning from showing the first page content to showing a second page content of the preset virtual scene page in the virtual viewing frame based on the target motion data to realize sliding showing of the preset virtual scene page in the virtual viewing frame.

According to one or more embodiments of the present disclosure, transitioning from showing the first page content to showing a second page content of the preset virtual scene page in the virtual viewing frame based on the target motion data includes:
querying a preset mapping relationship based on the target motion data to obtain a target page moving vector corresponding to the target motion data, wherein the preset mapping relationship includes a corresponding relationship between different motion data and page moving vectors;
determining the second page content of the preset virtual scene page based on the first page content and the target page moving vector; and
transitioning from showing the first page content to showing the second page content in the virtual viewing frame.

According to one or more embodiments of the present disclosure, the motion data includes a spatial rotation angle of a plane in which a screen of the mobile terminal is located.

According to one or more embodiments of the present disclosure, the method further includes:
entering a capture preview page in response to a triggering operation for the preset virtual scene page.

According to one or more embodiments of the present disclosure, after entering the capture preview page, the method further includes:
showing an associated element of the preset virtual scene page in the capture preview page.

According to one or more embodiments of the present disclosure, a first preset number of sub-theme entries of the preset theme are associated in the preset virtual scene page; while showing the second page content in the virtual viewing frame, the method further includes:

showing a sub-theme entry associated with the second page content in the virtual viewing frame,
where entering a capture preview page in response to a triggering operation for the preset virtual scene page and showing an associated element of the preset virtual scene page in the capture preview page includes:
entering the capture preview page in response to a triggering operation for a target sub-theme entry and showing an associated element of the target sub-theme entry in the capture preview page, wherein the target sub-theme entry is the sub-theme entry associated with the second page content.

According to one or more embodiments of the present disclosure, a second preset number of sub-theme objects of the preset theme are associated in the preset virtual scene page, and the virtual viewing frame includes a preset positioning identifier displayed fixedly; while showing the second page content in the virtual viewing frame, the method further includes:
showing a sub-theme object associated with the second page content in the virtual viewing frame,
where entering a capture preview page in response to a triggering operation for the preset virtual scene page and showing an associated element of the preset virtual scene page in the capture preview page includes:
entering the capture preview page in response to detecting a relative relationship of a first display region corresponding to the preset positioning identifier and a second display region corresponding to the target sub-theme object meeting a preset condition, and showing an associated element of the target sub-theme object in the capture preview page, wherein the target sub-theme entry is the sub-theme object associated with the second page content.

According to one or more embodiments of the present disclosure, the relative relationship of the first display region corresponding to the preset positioning identifier and the second display region corresponding to the target sub-theme object meeting the preset condition includes:
an area of an overlapping region of the first display region corresponding to the preset positioning identifier and the second display region corresponding to the target sub-theme object remaining greater than or equal to a preset area threshold within a preset duration.

One or more embodiments of the present disclosure provide an apparatus for controlling page display, the apparatus includes:
a display module, configured to fixedly display a virtual viewing frame in a target page of a mobile terminal and show a first page content of a preset virtual scene page in the virtual viewing frame, wherein the preset virtual scene page is associated with a preset theme, and associated information of the preset theme is shown outside the virtual viewing frame in the target page; and
a content changing module, configured to obtain target motion data of the mobile terminal and transition from showing the first page content to showing a second page content of the preset virtual scene page in the virtual viewing frame based on the target motion data to realize sliding showing of the preset virtual scene page in the virtual viewing frame.

In addition, while a plurality of operations have been described in a particular order, it shall not be construed as requiring that such operations are performed in the stated specific order or sequence. Under certain circumstances, multitasking and parallel processing may be advantageous. Similarly, while a plurality of implementation details are included in the above discussions, these shall not be construed as limitations to the present disclosure. Some features described in the context of a separate embodiment may also be combined in a single embodiment. Rather, the plurality of features described in the context of a single embodiment may also be implemented separately or in any appropriate sub-combination in a plurality of embodiments.

1. A method for controlling page display, comprising:
fixedly displaying a virtual viewing frame in a target page of a mobile terminal and showing a first page content of a preset virtual scene page in the virtual viewing frame, wherein the preset virtual scene page is associated with a preset theme, and associated information of the preset theme is shown outside the virtual viewing frame in the target page; and
obtaining target motion data of the mobile terminal and transitioning from showing the first page content to showing a second page content of the preset virtual scene page in the virtual viewing frame based on the target motion data to realize sliding showing of the preset virtual scene page in the virtual viewing frame.

2. The method according to claim 1, wherein the transitioning from showing the first page content to showing a second page content of the preset virtual scene page in the virtual viewing frame based on the target motion data comprises:
querying a preset mapping relationship based on the target motion data to obtain a target page moving vector corresponding to the target motion data, wherein the preset mapping relationship comprises a corresponding relationship between different motion data and page moving vectors;
determining the second page content of the preset virtual scene page based on the first page content and the target page moving vector; and
transitioning from showing the first page content to showing the second page content in the virtual viewing frame.

3. The method according to claim 2, wherein the motion data comprises a spatial rotation angle of a plane in which a screen of the mobile terminal is located.

4. The method according to claim 1, further comprising:
entering a capture preview page in response to a triggering operation for the preset virtual scene page.

5. The method according to claim 4, after the entering a capture preview page, further comprising:
showing an associated element of the preset virtual scene page in the capture preview page.

6. The method according to claim 5, wherein a first preset number of sub-theme entries of the preset theme are associated in the preset virtual scene page; while showing the second page content in the virtual viewing frame, the method further comprises:
showing a sub-theme entry associated with the second page content in the virtual viewing frame,
wherein the entering a capture preview page in response to a triggering operation for the preset virtual scene page and showing an associated element of the preset virtual scene page in the capture preview page comprises:
entering the capture preview page in response to a triggering operation for a target sub-theme entry and showing an associated element of the target sub-theme entry in the capture preview page, wherein the target sub-theme entry is the sub-theme entry associated with the second page content.

7. The method according to claim 5, wherein a second preset number of sub-theme objects of the preset theme are associated in the preset virtual scene page, and the virtual viewing frame comprises a preset positioning identifier displayed fixedly; while showing the second page content in the virtual viewing frame, the method further comprises:
showing a sub-theme object associated with the second page content in the virtual viewing frame,
wherein the entering a capture preview page in response to a triggering operation for the preset virtual scene page and showing an associated element of the preset virtual scene page in the capture preview page comprises:
entering the capture preview page in response to detecting a relative relationship of a first display region corresponding to the preset positioning identifier and a second display region corresponding to the target sub-theme object meeting a preset condition, and showing an associated element of the target sub-theme object in the capture preview page, wherein the target sub-theme object is the sub-theme object associated with the second page content.

8. The method according to claim 7, wherein the relative relationship of the first display region corresponding to the preset positioning identifier and the second display region corresponding to the target sub-theme object meeting the preset condition comprises:
an area of an overlapping region of the first display region corresponding to the preset positioning identifier and the second display region corresponding to the target sub-theme object remaining greater than or equal to a preset area threshold within a preset duration.

9. (canceled)

10. A mobile terminal, comprising a memory, a processor, and computer programs stored on the memory and runnable on the processor, wherein the processor, upon executing the computer programs, implements a method for controlling page display, and the method comprises:
fixedly displaying a virtual viewing frame in a target page of a mobile terminal and showing a first page content of a preset virtual scene page in the virtual viewing frame, wherein the preset virtual scene page is associated with a preset theme, and associated information of the preset theme is shown outside the virtual viewing frame in the target page; and
obtaining target motion data of the mobile terminal and transitioning from showing the first page content to showing a second page content of the preset virtual scene page in the virtual viewing frame based on the target motion data to realize sliding showing of the preset virtual scene page in the virtual viewing frame.

11. A non-transitory computer-readable storage medium, storing computer programs, wherein the computer programs, upon being executed by a processor, implement a method for controlling page display, the method comprises:
fixedly displaying a virtual viewing frame in a target page of a mobile terminal and showing a first page content of a preset virtual scene page in the virtual viewing frame, wherein the preset virtual scene page is associated with a preset theme, and associated information of the preset theme is shown outside the virtual viewing frame in the target page; and
obtaining target motion data of the mobile terminal and transitioning from showing the first page content to showing a second page content of the preset virtual scene page in the virtual viewing frame based on the target motion data to realize sliding showing of the preset virtual scene page in the virtual viewing frame.

12. (canceled)

13. The mobile terminal according to claim 10, wherein the transitioning from showing the first page content to showing a second page content of the preset virtual scene page in the virtual viewing frame based on the target motion data comprises:
querying a preset mapping relationship based on the target motion data to obtain a target page moving vector corresponding to the target motion data, wherein the preset mapping relationship comprises a corresponding relationship between different motion data and page moving vectors;
determining the second page content of the preset virtual scene page based on the first page content and the target page moving vector; and
transitioning from showing the first page content to showing the second page content in the virtual viewing frame.

14. The mobile terminal according to claim 13, wherein the motion data comprises a spatial rotation angle of a plane in which a screen of the mobile terminal is located.

15. The mobile terminal according to claim 10, further comprising:
entering a capture preview page in response to a triggering operation for the preset virtual scene page.

16. The mobile terminal according to claim 15, after the entering a capture preview page, further comprising:
showing an associated element of the preset virtual scene page in the capture preview page.

17. The mobile terminal according to claim 16, wherein a first preset number of sub-theme entries of the preset theme are associated in the preset virtual scene page; while showing the second page content in the virtual viewing frame, the method further comprises:
showing a sub-theme entry associated with the second page content in the virtual viewing frame,
wherein the entering a capture preview page in response to a triggering operation for the preset virtual scene page and showing an associated element of the preset virtual scene page in the capture preview page comprises:
entering the capture preview page in response to a triggering operation for a target sub-theme entry and showing an associated element of the target sub-theme entry in the capture preview page, wherein the target sub-theme entry is the sub-theme entry associated with the second page content.

18. The mobile terminal according to claim 16, wherein a second preset number of sub-theme objects of the preset theme are associated in the preset virtual scene page, and the virtual viewing frame comprises a preset positioning identifier displayed fixedly; while showing the second page content in the virtual viewing frame, the method further comprises:
showing a sub-theme object associated with the second page content in the virtual viewing frame,
wherein the entering a capture preview page in response to a triggering operation for the preset virtual scene page and showing an associated element of the preset virtual scene page in the capture preview page comprises:
entering the capture preview page in response to detecting a relative relationship of a first display region corresponding to the preset positioning identifier and a second display region corresponding to the target sub-theme object meeting a preset condition, and showing an associated element of the target sub-theme object in the capture preview page, wherein the target sub-theme object is the sub-theme object associated with the second page content.

19. The mobile terminal according to claim 18, wherein the relative relationship of the first display region corresponding to the preset positioning identifier and the second display region corresponding to the target sub-theme object meeting the preset condition comprises:
an area of an overlapping region of the first display region corresponding to the preset positioning identifier and the second display region corresponding to the target sub-theme object remaining greater than or equal to a preset area threshold within a preset duration.
